(19) United States
(12) Patent Application Publication
(10) Pub. No.: US 2022/0318824 A1
(43) Pub. Date: Oct. 6, 2022

(54) System and Method to Determine the Value of Scientific Expertise in Large Scale Experimentation

(71) Applicant: Toyota Research Institute, Inc., Los Altos, CA (US)

(72) Inventor: Rumen Iliev, Millbrae, CA (US)

(73) Assignee: Toyota Research Institute, Inc., Los Altos, CA (US)

(21) Appl. No.: 17/222,485

(22) Filed: Apr. 5, 2021

(51) Int. Cl. G06Q 30/02

(52) U.S. Cl. CPC G06Q 30/0201; G06Q 30/0203; G06Q 30/0204; G06Q 30/0206

(57) ABSTRACT

Systems and methods to determine the value of scientific expertise in large scale experimentation are disclosed. In one embodiment, a method includes receiving a cost of performing a controlled experiment to test a plurality of interventions associated with a metric of interest, receiving a distribution of expected effect sizes associated with the interventions, receiving a level of expertise associated with the metric of interest, generating sample data for a plurality of simulated trials of the experiment, generating a sample ordering of the plurality of interventions for each of the plurality of simulated trials, simulating a plurality of trials of the experiment using the sample data and the sample orderings of the interventions, and determining a first value indicating an amount that the metric of interest will be improved from hiring an expert compared to not hiring an expert based on the results of simulating the plurality of trials.

### TECHNICAL FIELD

The present specification relates to data science, and more particularly, to a system and method to determine the value of scientific expertise in large scale experimentation.

### BACKGROUND

Many organizations are able to run large scale social science experiments involving a large number of variables and a large number of participants thanks to the increasing availability of computing power. For example, social media companies, online shopping platforms, on-demand mobility services, and other organizations may have access to a large number of users or customers. These users may utilize a website, a smartphone application, or other platforms to purchase goods and services or otherwise interact with a company, organization, or other users. As such, an organization may desire to run A/B tests or other types of experiments to determine an optimal website design, graphical user interface, or other platform to maximize a particular objective. An objective to be maximized may be sales, page views, clicks on certain hyperlinks, and the like.

Because certain organizations have large user bases, sometimes with millions of users, these organizations may be able to run these types of experiments and collect sufficient data from the experiments to determine optimal features to maximize particular objectives. However, in addition to running experiments, it may be beneficial to hire one or more experts to provide insight into how the experiment should be run to maximize the objective. An expert may be able to reduce the amount of experimentation needed to maximize an objective, thereby saving time, money, or other resources. However, it may be difficult to determine whether hiring an expert would be beneficial when performing experiments. Accordingly, there is a need for alternative systems and methods that determine the value of scientific expertise in large scale experimentation.

### SUMMARY

In an embodiment, a method may include receiving a cost of performing a controlled experiment to test a plurality of interventions associated with a metric of interest, receiving a distribution of expected effect sizes associated with the plurality of interventions, receiving a level of expertise associated with the metric of interest, generating sample data for a plurality of simulated trials of the experiment based on the distribution of expected effect sizes, generating a sample ordering of the plurality of interventions for each of the plurality of simulated trials of the experiment based on the level of expertise associated with the metric of interest, simulating a plurality of trials of the experiment using the generated sample data and the generated sample orderings of the plurality of interventions, and determining a first value indicating an amount that the metric of interest will be improved from hiring an expert compared to not hiring an expert based on the results of simulating the plurality of trials.

In an embodiment, a system may include a processing device, and a non-transitory, processor-readable storage medium comprising one or more programming instructions stored thereon. When executed, the programming instructions may cause the processing device to receive a cost of performing a controlled experiment to test one or more interventions associated with a metric of interest, receive a distribution of expected effect sizes associated with the plurality of interventions, receive a level of expertise associated with the metric of interest, generate sample data for a plurality of simulated trials of the experiment based on the distribution of expected effect sizes, generate a sample ordering of interventions for each of the plurality of simulated trials of the experiment based on the level of expertise associated with the metric of interest, simulate a plurality of trials of the experiment using the generated sample data and the generated sample orderings of the plurality of interventions, and determine a first value indicating an amount that the metric of interest will be improved from hiring an expert compared to not hiring an expert based on the results of simulating the plurality of trials.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an illustrative computing network to determine the value of scientific expertise in large scale experimentation;

FIG. 2 schematically depicts the server computing device from FIG. 1, further illustrating hardware and software that may be used in content framing monitoring and intervention according to one or more embodiments shown and described herein;

FIG. 3 depicts a flow diagram of an illustrative method of determining the value of scientific expertise in large scale experimentation, according to one or more embodiments shown and described herein; and

FIG. 4 depicts a flow diagram of another illustrative method of determining the value of scientific expertise in large scale experimentation, according to one or more embodiments shown and described herein.

### DETAILED DESCRIPTION

The embodiments disclosed herein describe a system and method to determine the value of scientific expertise in large scale experimentation. An organization may run A/B testing or other types of experiments to assess the value of certain features or interventions contributing to an objective or metric of interest. A/B testing typically involves randomly splitting users into a control group and a treatment group. The control group may be presented with a known set of features or interventions (e.g., a typical website view or user interface), while the treatment group may be presented with a new feature or intervention being tested. For example, the treatment group may be presented with a website in which a portion of the website has a modified font or color or arrangement of icons.

In embodiments disclosed herein, A/B testing and other types of experimentation are primarily directed to behavioral science experiments. That is, experiments are used to determine how different features affect human behavior in some way. However, in some examples, A/B testing and other types of experimentation may be used in areas other than behavioral science. For example, A/B testing may be used to apply different conditions to connected vehicles (e.g., different levels of current drawn from an electric battery) and vehicle performance may then be measured for the different conditions.

In embodiments, either related to behavioral science or other areas, after an experiment is performed, an objective or metric of interest may be measured for the control group and the treatment group. The metric of interest may relate to a desired outcome. For example, a metric of interest may comprise online sales of a product, click rate of certain hyperlinks at a website, viewing times of online videos, and the like. For example, an A/B testing experiment may be designed to test whether a change in font on a website causes more users to click on a particular link. In this example, the control group may be presented with a previously used font while the treatment group may be presented with a different font to be tested. The experiment may measure how often each group clicks on the link. If the treatment group clicks on the link more than the control group, it may be determined that the feature (the new font) increases the metric of interest (clicks). If the metric of interest is increased, the new feature may be integrated into future versions of the platform.

Because organizations such as social media companies and online shopping platforms have access to a large number of users, many such experiments may be run concurrently or simultaneously. In fact, many internet-based companies are running thousands of such experiments at any given time. Many organizations have custom experimentation platforms to facilitate the running of such experiments. This may allow experiments to test multiple features. For example, an experiment as described above to maximize clicks on a link may test features including font, font size, font color, font placement, and the like, and all combinations thereof.

However, there may be a cost associated with running experiments. This may include time, money, computing resources, or other costs. The more interventions that are tested in a given experiment, the greater the cost is likely to be. As such, it may be desirable to limit the number of interventions tested in an experiment. In particular, it may be desirable to test the interventions that are more likely to have a result on the metric of interest before testing interventions that are less likely to have a result on the metric of interest. As such, positive results may be obtained earlier and the experiment may be stopped before all the interventions are tested, thereby reducing costs.

However, without a priori knowledge, it may be difficult to determine which interventions are more likely to affect the metric of interest. As such, it may be desirable to hire an expert with knowledge in the field to provide such a priori knowledge. If such an expert is available, the expert may be able to provide an initial ordering of interventions to be tested based on which interventions are more likely to effect the metric of interest. The experiment may then be run using the ordering of features provided by the expert. As such, the experiment may provide better results earlier than if the experiment had been run without consulting an expert.

Before the advent of big data, behavioral science experiments were primarily the domain of academic institutions and psychology labs. Experiments run in these settings allowed a corpus of knowledge about human behavior to be built up over time. In particular, certain individuals (e.g., university professors or other professionals in research labs) were able to gain expertise in certain areas related to human behavior. However, more recently, the computing resources and customer base available to technology companies has somewhat obviated the need for such expertise in certain settings as experiments can be run that exhaustively test a wide range of interventions. However, as explained above, there may still be benefits to hiring an expert before running an experiment in behavior science or other areas.

There is also a cost of hiring an expert, however. Thus, it may be desirable to quantify how much an experiment will be improved by consulting an expert. Then, it can be objectively decided whether the benefit of hiring an expert is likely to outweigh the cost. Accordingly, as disclosed herein, a system is provided that receives as input, a cost of running an experiment to test certain interventions, a distribution of effect sizes associated with the interventions, and a level of expertise associated with the field associated with the experiment, and/or the metric of interest associated with the experiment. The system may then output a value indicating how much the metric of interest will be improved if an expert is consulted before running the experiment compared to running the experiment without consulting an expert. The system may determine this value either using a closed-form solution or using simulations, as disclosed herein. A user may then determine whether to hire an expert based on this value.

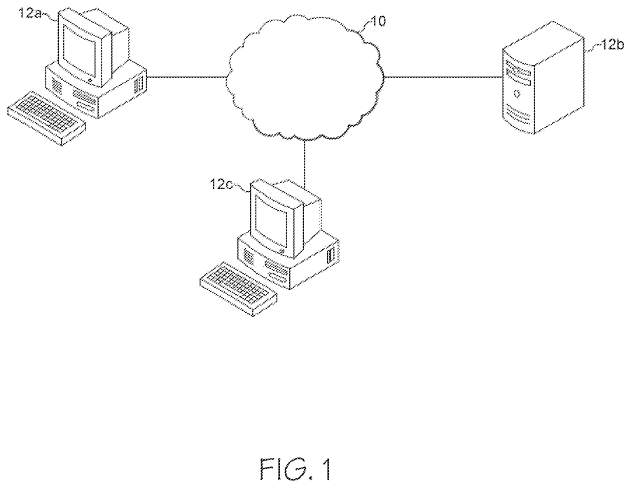

Referring now to the drawings, FIG. 1 depicts an illustrative computing network, illustrating components of a system for performing the functions described herein, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c.

The user computing device 12a may be used to input information to be utilized to determine the value of scientific expertise in large scale experiments, as disclosed herein. For example, the user computing device 12a may be a personal computer running software that that user utilizes to input information about potential experiments to be run (e.g., A-B tests). The types of information input are disclosed in further detail below. After this information is input into the user computing device 12a, the user computing device 12a or the server computing device 12b may perform the techniques disclosed herein to determine the value of scientific expertise in large scale experiments. In some examples, the user computing device 12a may be a tablet, a smartphone, a smart watch, or any other type of computing device used by a user to input information related to experiments.

The administrator computing device 12c may, among other things, perform administrative functions for the server computing device 12b. In the event that the server computing device 12b requires oversight, updating, or correction, the administrator computing device 12c may be configured to provide the desired oversight, updating, and/or correction. The administrator computing device 12c, as well as any other computing device coupled to the computer network 10, may be used to input historical cost data or historical effect size data into a database.

The server computing device 12b may receive information input into the user computing device 12a and may perform the techniques disclosed herein to determine the value of scientific expertise in large scale experiments. The server computing device 12b may then transmit information to be displayed by the user computing device 12a based on the operations performed by the server computing device 12b. In some examples, the server computing device 12b may be removed from the system of FIG. 1 and may be replaced by a software application on the user computing device 12a. For example, the functions of the server computing device 12b may be performed by software operating on the user computing device 12a. The components and functionality of the server computing device 12b will be set forth in detail below.

It should be understood that while the user computing device 12a and the administrator computing device 12c are depicted as personal computers and the server computing device 12b is depicted as a server, these are non-limiting examples. More specifically, in some embodiments any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the user computing device 12a, the server computing device 12b, and the administrator computing device 12c may represent a plurality of computers, servers, databases, etc.

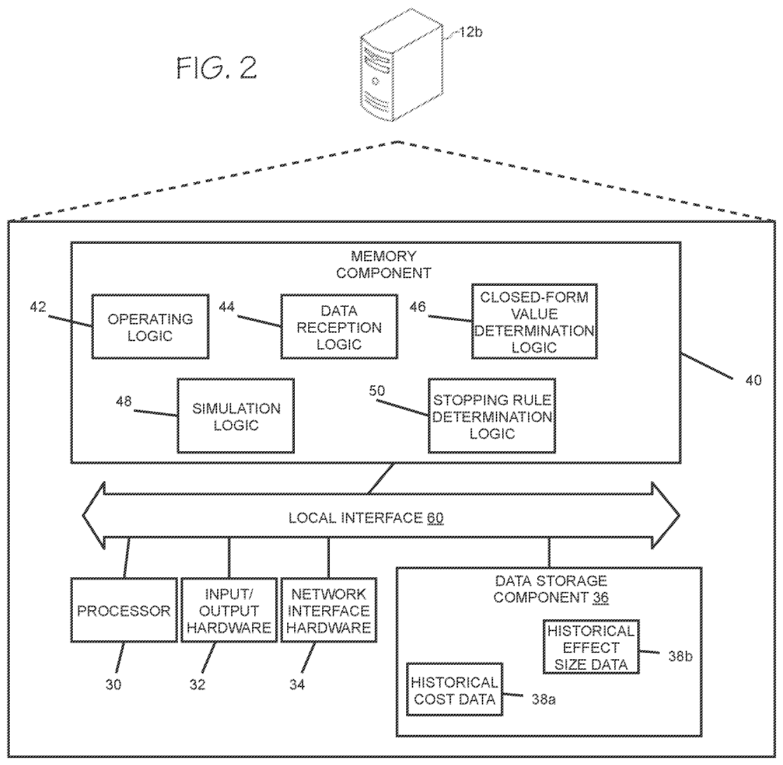

FIG. 2 depicts additional details regarding the server computing device 12b from FIG. 1. While in some embodiments, the server computing device 12b may be configured as a general purpose computer with the requisite hardware, software, and/or firmware, in some embodiments, that server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36 (which may store historical costs data 38a and historical effect size data 38b), and a non-transitory memory component 40. The memory component 40 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42, data reception logic 44, closed-form value determination logic 46, simulation logic 48, and stopping rule determination logic 50 (each of which may be embodied as a computer program, firmware, or hardware, as an example). A local interface 60 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components. As illustrated in FIG. 2, the data storage component 36 may store the historical cost data 38a and the historical effect size data 38b, described in further detail below.

Included in the memory component 40 are the operating logic 42, the data reception logic 44, the closed-form value determination logic 46, the simulation logic 48, and the stopping rule determination logic 50. The operating logic 42 may include an operating system and/or other software for managing components of the server computing device 12b.

The data reception logic 44 may receive data from a user associated with a proposed experiment (e.g., from the user computing device 12a). In particular, the data reception logic 44 may receive information about a cost of performing an experiment, a distribution of expected effect sizes associated with an experiment, and a level of expertise associated with an experiment, as disclosed in further detail below.

One type of data associated with an experiment that may be received by the data reception logic 44 relates to a cost of performing an experiment. As discussed above, performing an experiment may involve a number of different costs. These costs may be measured in dollars, time, computing resources, or other metrics. These costs may involve paying employees or contractors to set up, run and monitor an experiment. The costs may involve computing resources needed to run the experiments (e.g., usage of hardware or creation of software). The costs may also involve other costs of performing the experiments and testing interventions.

A cost of an experiment may depend on the number of features or interventions involved in the experiment. For example, a simple A-B test may compare a single feature or intervention against a baseline to determine an effect on a particular metric (e.g., how changing a font size of links on a website affects click rate). However, many experiments are multivariate experiments involving a large number of features or interventions to be tested. For example, a design of a website may be modified in a number of different ways to measure the effect on click rate of links (e.g., different font, font size, font color, placement on the web site, etc.). During the experiment, each of these interventions may be presented to different test subjects and data may be collected to determine the effectiveness of each of the interventions at improving the metric of interest.

Accordingly, a cost of an experiment may depend on the number of interventions to be tested since each intervention may require additional resources of some kind. Each intervention of n interventions to be tested may have a cost cₙ and a total cost of the experiment may be C={c₁, . . . , cₙ}. In some examples, the cost of an experiment may increase linearly as the number of interventions in an experiment increase. That is, each intervention cₙ may have the same cost. However, in other examples, the cost of an experiment may increase in a non-linear manner as the number of interventions in an experiment increase. For example, the first few interventions may be relatively expensive. However, as additional interventions are added, economies of scale may reduce the cost of testing additional interventions.

In some examples, the cost of an experiment may be based on historical cost data. In some examples, historical cost data 38a may be stored in the data storage component 36, which may be accessed by the data reception logic 44 to determine costs of an experiment.

Another type of data associated with an experiment that may be received by the data reception logic 44 is a distribution of expected effect sizes. As discussed above, an experiment may comprise testing a large number of interventions to determine how each intervention affects a particular metric of interest. A metric of interest may be any desired effect (e.g., click rate of links, online sales, viewing time of videos, etc.). Each intervention may or may not affect the metric of interest. Furthermore, each intervention may affect the metric of interest to a greater or lesser degree. The amount that a particular intervention affects the metric of interest may be defined as a gain for that intervention. In some examples, gain may be normalized between 0 and 1, wherein 0 represents no change or a decrease in the metric of interest and 1 represents a maximum possible increase in the metric of interest.

A distribution of expected effect sizes may comprise an indication of the expected gain for each of the interventions. The gain associated with each intervention is generally not known before running the experiment. In fact if the gain of each intervention were known before running the experiment, there would be no need to run the experiment. However, past experience running other experiments may give an indication as to how many interventions will have a significant effect on the metric of interest. For example, it may be known that for certain types of experiments, about 10% of the interventions tend to affect the metric of interest.

For less mature technologies (e.g., systems where not many previous experiments have been run), it is likely that more interventions will affect the metric of interest. For example, for some applications that have not been explored with many past experiments, many interventions may have an effect. However for more mature technologies (e.g., systems where many previous experiments have been run), it is likely that many features have already been selected to optimize the metric of interest over time based on previous experiments or other innovations. Behavior environments tend to be a product of a long sequence of cultural, social, physical, and virtual adaptations. As such, interventions that have an effect on mature systems may be more difficult to find and interventions that do significantly affect the metric of interest are likely to be rarer.

The set of gains for all of the interventions associated with an experiment may comprise a distribution of expected effect sizes. The data reception logic 44 may receive a distribution of expected effect sizes in a variety of forms. In some examples, the data reception logic 44 may receive an expected normalized gain associated with each intervention of an experiment. In other examples, the data reception logic 44 may instead receive a rarity coefficient indicating how rare interventions having significant gain are expected to be. In some examples, the rarity coefficient may indicate a percentage of interventions that are expected to affect the metric of interest by more than a predetermined threshold amount. In some examples, this threshold may depend on the cost (e.g., the threshold may be higher for more costly interventions).

In some examples, the gain g associated with each of n interventions may belong a set G and may be ordered as a power function

$$P = \{ {g}_{1} , ... , {g}_{n} \vert {g}_{i} ϵ G , {g}_{i} = {( \frac{1}{n} )}^{a} \}$$

and a rarity coefficient r may be defined as the area above the power function such that

$$r = 1 - \frac{1}{a + 1} .$$

When r approaches 1, substantial gains are very rare and when r approaches 0, substantial gains are very common. In other examples, the rarity coefficient r may be defined in other ways to indicate how rare interventions having significant effects on the metric of interest are likely to occur.

In some examples, the expected effect size distribution may be based on historical effect size data. In some examples, historical effect size data 38b may be stored in the data storage component 36, which may be accessed by the data reception logic 44 to determine a distribution of expected effect sizes.

Another type of data associated with an experiment that may be received by the data reception logic 44 is a level of expertise associated with the metric of interest for an experiment. As discussed above, for an experiment that tests a large number of interventions, it is likely that only a small number of the interventions will have a significant effect on the metric of interest (e.g., having a high gain value). Accordingly, it may be preferable to test the interventions with a higher gain before testing the interventions with a lower gain. This may allow the experiment to achieve significant results earlier than if interventions with a lower gain are tested before interventions with a higher gain. Accordingly, the interventions may be ordered from those having the highest expected gain to those having the lowest expected gain. The experiment may then test the interventions in this order.

However, this ordering of interventions based on expected gain is generally not known a priori. As such, in the absence of expert knowledge in the field, an experiment may test the interventions in a random order. While this will eventually achieve the desired results after all of the interventions are tested, it may be less efficient than testing the interventions in a more thoughtful order. As such, it may be desirable to hire an expert in the field.

An expert may be a domain specialist in the field associated with the metric of interest. The expert may have acquired domain knowledge through experience in academia, industry, or other areas related to the metric of interest. Based on this experience, the expert may be able to predict an ordering of interventions based on how likely the interventions are to effect the metric of interest.

In certain areas, there may be a high level of expertise in the field. That is, an expert may be able to predict an ordering of interventions based on their expected gain to a high degree of accuracy. In other areas, there may be a low level of expertise in the field. That is, an expert may not be able to predict an ordering of interventions based on their expected gain to a high degree of accuracy. In some examples, a user may determine a level of expertise that exists in the field by pursuing the academic literature associated with the field. In other examples, a user may determine a level of expertise that exists in the field using other techniques. In embodiments, it is assumed that the level of expertise that exists in the field may be quantified, as disclosed herein.

In embodiments, a level of expertise that exists in a field may be normalized between 0 and 1. An expert may predict an ordering P′ of the interventions associated with an experiment. The higher the level of expertise, the closer the expert predicted ordering P′ will be to a perfect ordering P of the interventions. An expertise level of 0 means that an expert's ordering of interventions will be no better than a random ordering. An expertise level of 1 means that an expert will be able to perfectly order the interventions from highest gain to lowest gain. A level of expertise in between 0 and 1 means that an expert will be able to predict the ordering better than a random ordering but less than a perfect ordering. In some examples, the normalized level of expertise may be based on a similarity between the expert predicted ordering P′ and the perfect ordering P of the interventions.

In the illustrated example, the data reception logic 44 may receive a value between 0 and 1 indicating a normalized level of expertise that exists in the field associated with the experiment. In other examples, the data reception logic 44 may receive other indications of the level of expertise that exists in the field associated with the experiment.

After the data reception logic 44 receives a cost, a distribution of expected effect sizes, and a level of expertise associated with an experiment, the server computing device 12b may determine a value indicating an amount that the metric of interest will be improved by hiring an expert compared to not hiring an expert, as disclosed herein. The value of hiring an expert may depend on the cost, the distribution of expected effect sizes, and the level of expertise. For example, if the cost of running the experiment is high, there may be more value in hiring an expert since testing additional interventions in a sub-optimal order is more costly. Furthermore, if the distribution of effect sizes is such that interventions that significantly affect the metric of interest are rare, hiring an expert may be more valuable since testing the interventions in a random ordering may require more testing before the valuable interventions are tested. Lastly, if the level of expertise is high, hiring an expert may be more valuable since an expert may be able to better to order the interventions.

In some examples disclosed herein, the server computing device 12b may determine the value of hiring an expert using a closed-form solution. In other examples disclosed herein, the server computing device 12b may determine the value of hiring an expert by performing a simulation. Each of these examples is discussed in further detail below.

In embodiments, the value of hiring an expert for an experiment may be measured in the same metric as the metric of interest of the experiment. For example, if the metric of interest is click rate on a website, the value of hiring an expert may be measured in increased click rate. Alternatively, if the metric of interest is online sales, than the value of hiring an expert may be measured in increased sales. As such, the server computing device 12b may indicate a value corresponding to how much the metric of interest is expected to increase if an expert is hired. Accordingly, a user may consider the cost of hiring the expert and may determine whether hiring the expert is worthwhile.

Referring to FIG. 2, the closed-form value determination logic 46 may determine the value of hiring an expert using a closed-form solution. The closed form solution may depend on the cost, distribution of expected effect sizes, and level of expertise received by the data reception logic 44. For example, the value V of hiring an expert may be defined by a function f such that V=f(G, P′, C). The values G, P′, and C may represent the expected gains from the interventions, the expert-predicted ordering of the interventions, and the cost of the interventions described above. The function f may take a variety of forms and may weight each of the inputs differently in different examples. After determining the value V, the server computing device 12b may output the value to a user. For example, the server computing device 12b may transferred the determined value to the user computing device 12a for display to a user. The user may then determine whether to hire an expert based on the determined value.

Referring still to FIG. 2, the simulation logic 48 may determine the value by performing one or more simulations. In some examples, an experiment may be performed using an experimentation platform. Different organizations may have different experimentation platforms with different features. An experimentation platform may allow a user to input parameters of the experiment and may then collect data from the implementation of the experiment and perform data analysis on the collected data.

Different experimentation platforms may collect and analyze data in different manners. Some platforms may monitor for interventions that have negative results (e.g., interventions that decrease the metric of interest). Some platforms may reject negative results faster than they accept positive results. Some platforms may allow for experiments of larger sizes than others (e.g., experiments having more interventions). Some platforms may allow for non-linear costs (e.g., experiments where different interventions have different costs and the overall cost does not increase linearly with increased interventions).

In embodiments, the simulation logic 48 may simulate an experimentation platform. That is, the simulation logic 48 may comprise a scale model of an experimentation platform. The simulation logic 48 may collect sample data and may analyze the data in a manner similar to an actual experimentation platform. The simulation logic 48 may simulate different experimentation platforms based on the parameters of the experimentation platforms.

After a scale model of an experimentation platform is created, the simulation logic 48 may simulate experiments being performed using the scale model of the experimentation platform. For example, an example ordering of the interventions may be determined based on the level of expertise and sample data may be generated based on the distribution of expected effect sizes. The simulation logic 48 may then analyze the sample data according to the parameters of the experimentation platform being simulated and may output a value for the metric of interest.

The simulation logic 48 may simulate multiple trials of the experiment (e.g., 10,000 trials). Each time that a trial is simulated, a different ordering of interventions may be used based on the level of expertise and different sample data may be generated based on the distribution of expected effect sizes. For example, if the normalized level of expertise is 0, the interventions may be ordered randomly for each trial. If the normalized level of expertise is 1, the interventions may be perfectly ordered for each trial. If the normalized level of expertise is between 0 and 1, the interventions may be ordered in a way that is better than a random ordering but is worse than a perfect ordering based on the normalized level of expertise.

With respect to the sample data, the simulation logic 48 may generate sample data based on the distribution of expected effect sizes. That is, because effect sizes have a known distribution, the simulation logic 48 may generate data that, over time, corresponds to the known distribution. Each trial may be simulated by the simulation logic 48 using the sample data and ordering of interventions and the resulting value from all of the trials may be averaged to determine an expected value for the experiment. The expected value may indicate an amount that the metric of interest is expected to increase if an expert is hired compared to performing the experiment without hiring an expert.

Referring still to FIG. 2, the stopping rule determination logic 50 may determine when an experiment should be stopped. As discussed above, if the interventions are ordered in a non-random way, the earlier tested interventions are more likely to have a significant effect on the metric of interest than the later tested interventions. At the same time, testing each intervention will have a cost (e.g., a linear or non-linear cost). Thus, as each intervention is tested, the cost will remain the same (or may increase if the costs are non-linear), while the expected value of testing each intervention will decrease. Accordingly, at some point, the cost of testing additional interventions may exceed the value of testing those interventions. At this point, it no longer makes sense to continue testing additional interventions.

The stopping rule determination logic 50 may determine a stopping rule when it no longer makes sense to continue testing additional interventions. In one example, the simulation logic 48 may simulate the implementation of an experiment over multiple trials. With each trial, the simulation logic 48 may determine the cost of each additional intervention and may also determine the value of each intervention (e.g., how much the metric of interest increases with each additional intervention tested). The simulation logic 48 may then average this across all trials in order to determine an expected cost of testing each additional intervention and an expected value from testing each intervention. The stopping rule determination logic 50 may then determine when the cost of testing additional interventions exceeds the value of testing additional interventions. For example, the stopping rule determination logic 50 may determine that for an experiment with 100 interventions, the value of testing the first 20 interventions exceeds the cost of testing the first 20 interventions but the value of testing the 21^{st} intervention is less than the cost of the 21^{st} intervention. Accordingly, the stopping rule determination logic 50 may determine a stopping rule that the experiment should stop after testing the first 20 interventions.

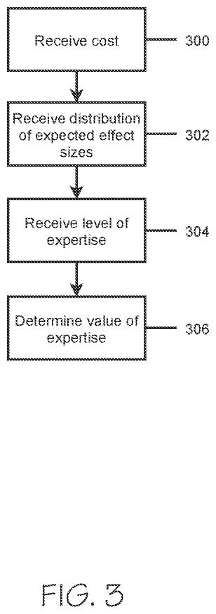

As mentioned above, the various components described with respect to FIG. 2 may be used to carry out one or more processes and/or provide functionality for determining the value of scientific expertise in large scale experiments. An illustrative example of the various processes is described with respect to FIG. 3. In the example of FIG. 3, the value of expertise is determined using a closed-form solution. Although the steps associated with the blocks of FIG. 3 will be described as being separate tasks, in other embodiments, the blocks may be combined or omitted. Further, while the steps associated with the blocks of FIG. 3 will be described as being performed in a particular order, in other embodiments, the steps may be performed in a different order.

At step 300, the data reception logic 44 receives a cost of an experiment to measure the effect of a plurality of interventions on a metric of interest. In some examples, the data reception logic 44 may receive a cost of testing each intervention. In some examples, the cost of each intervention may be linear. In other examples, the cost of each intervention may be non-linear.

At step 302, the data reception logic 44 receives a distribution of expected effect sizes for the interventions associated with the experiment. In some examples, the distribution of expected effect sizes may indicate an expected gain of each intervention. In some examples, the distribution of expected effect sizes may indicate how many interventions are expected to have a significant effect on the metric of interest (e.g., how many interventions are expected to have a gain greater than a predetermined threshold amount). In some examples, the distribution of expected effect sizes may comprise a rarity coefficient indicating how rare interventions that have a significant effect on the metric of interest are expected to occur.

At step 304, the data reception logic 44 receives a level of expertise associated with the metric of interest. In some examples, the level of expertise is a normalized value between 0 and 1 indicating how closely an expert determined ordering of interventions from greatest gain to smallest gain is expected to be to a perfect ordering of interventions from greatest gain to smallest gain.

At step 306, the closed-form value determination logic 46 determines the value of hiring an expert based on the cost, distribution of expected effect sizes, and level of expertise received by the data reception logic 44. Specifically, the closed-form value determination logic 46 determines how much the metric of interest will be increased when an expert is hired compared to when an expert is not hired. The closed-form value determination logic 46 determines this value using a closed-form solution. The value may then be output to a user.

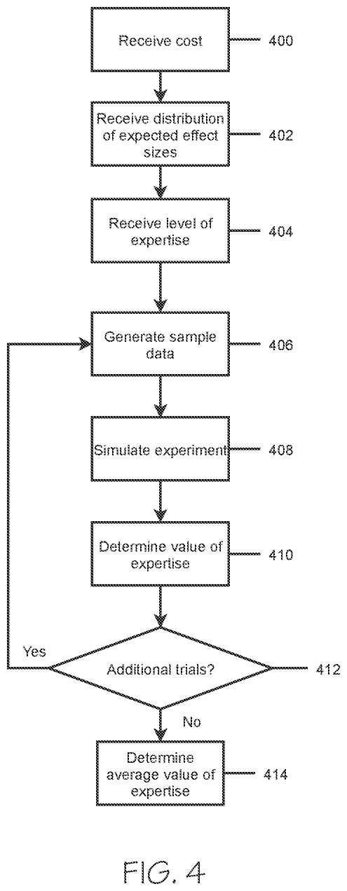

Another illustrative example of a process for determining the value of scientific expertise in large scale experiments is shown in FIG. 4. In the example of FIG. 4, the value of expertise is determined using simulation results.

At step 400, the data reception logic 44 receives a cost of an experiment to measure the effect of a plurality of interventions on a metric of interest. In some examples, the data reception logic 44 may receive a cost of testing each intervention. In some examples, the cost of each intervention may be linear. In other examples, the cost of each intervention may be non-linear.

At step 402, the data reception logic 44 receives a distribution of expected effect sizes for the interventions associated with the experiment. In some examples, the distribution of expected effect sizes may indicate an expected gain of each intervention. In some examples, the distribution of expected effect sizes may indicate how many interventions are expected to have a significant effect on the metric of interest (e.g., how many interventions are expected to have a gain greater than a predetermined threshold amount). In some examples, the distribution of expected effect sizes may comprise a rarity coefficient indicating how rare interventions that have a significant effect on the metric of interest are expected to occur.

At step 404, the data reception logic 44 receives a level of expertise associated with the metric of interest. In some examples, the level of expertise is a normalized value between 0 and 1 indicating how closely an expert determined ordering of interventions from greatest gain to smallest gain is expected to be to a perfect ordering of interventions from greatest gain to smallest gain.

At step 406, the simulation logic 48 generates sample data for one trial of the experiment. In some examples, the sample data may be generated based on the distribution of expected effect sizes received by the data reception logic 44. In particular, the simulation logic 48 may generate sample data having a distribution matching the distribution of the expected effect sizes received by the data reception logic 44.

At step 408, the simulation logic 48 simulates one trial of the experiment based on the cost, the distribution of expected effect sizes, and the level of expertise received by the data reception logic 44, and based on the sample data generated by the simulation logic 48. The simulation logic 48 may simulate a trial of the experiment as if performed on a particular experimentation platform having certain parameters. That is, the simulation logic 48 may simulate an experimentation platform and may simulate the performance of the experimentation platform upon receiving the sample data. In particular, the simulation logic 48 may simulate one trial of the experiment using an ordering of the interventions based on the level of expertise received by the data reception logic 44.

At step 410, the simulation logic 48 determines the value of hiring an expert based on the results of the simulation of one trial of the experiment. Specifically, the simulation logic 48 may determine the increase in the metric of interest based on the ordering of interventions compared to not hiring an expert and using a random ordering of interventions.

At step 412, the simulation logic 48 determines whether additional trials are to be run. For example, the server computing device 12b may simulate a certain number of trials of the experiment (e.g., 10,000 trials). Thus, the simulation logic 48 may determine whether all of the trials to be run have been or if additional trials need to be to reach the desired number of trials. If the simulation logic 48 determines that additional trials are to be run (yes at step 412), then control returns to step 406 and additional sample data is generated. If the simulation logic 48 determines that additional trails are not to be run (no at step 412), then control passes to step 414.

At step 414, the simulation logic 48 determines the average value of expertise based on the simulation results of all of the trials. That is, the simulation logic 48 averages the values determined at step 410 for all of the trials run and determines an average of these values. This average value may then be output to a user.

It should now be understood that embodiments described herein are directed to systems and methods for to determine the value of scientific expertise in large scale experiments. An experiment may be desired to be performed to test a plurality of interventions to measure the effect of each intervention on a particular metric of interest. A system may receive a cost of each intervention to be tested, a distributed of expected effect sizes, and a level of expertise in the field associated with the experiment. The system may then determine an expected value of how much the metric of interest will be increased by hiring an expert compared with not hiring an expert. The system may determine this value either by using a closed-form solution or by simulating the experiment on a scale model of an experimentation platform.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method comprising:
receiving a cost of performing a controlled experiment to test a plurality of interventions associated with a metric of interest;
receiving a distribution of expected effect sizes associated with the plurality of interventions;
receiving a level of expertise associated with the metric of interest;
generating, by a processor, sample data for a plurality of simulated trials of the experiment based on the distribution of expected effect sizes;
generating, by the processor, a sample ordering of the plurality of interventions for each of the plurality of simulated trials of the experiment based on the level of expertise associated with the metric of interest;
simulating, by the processor, a plurality of trials of the experiment using the generated sample data and the generated sample orderings of the plurality of interventions; and
determining, by the processor, a first value indicating an amount that the metric of interest will be improved from hiring an expert compared to not hiring an expert based on the results of simulating the plurality of trials.

2. The method of claim 1, wherein the cost comprises the cost of testing each of the plurality of interventions.

3. The method of claim 1, wherein the cost of performing the controlled experiment is based on historical cost data.

4. The method of claim 1, wherein the distribution of expected effect sizes comprises a gain in the metric of interest expected to be produced by each of the plurality of interventions.

5. The method of claim 4, wherein the distribution of expected effect sizes is characterized by a rarity coefficient indicating how many of the plurality of interventions are expected to produce a gain in the metric of interest greater than a predetermined threshold.

6. The method of claim 5, wherein the rarity coefficient is a normalized value between 0 and 1.

7. The method of claim 1, wherein the distribution of expected effect sizes is based on historical effect size data.

8. The method of claim 1, wherein the level of expertise is based on a similarity between a first ordering of the plurality of interventions, ordered by a gain expected to be produced in the metric of interest for each of the plurality of interventions as predicted by an expert, and a second ordering of the plurality of interventions, ordered by the gain actually produced in the metric of interest for each of the plurality of interventions.

9. The method of claim 8, wherein the level of expertise is a normalized value between 0 and 1.

10. The method of claim 1, wherein the level of expertise associated with the metric of interest is based on an amount of coverage of the metric of interest in academic literature.

11. The method of claim 1, wherein the controlled experiment comprises A/B testing of each of the plurality of interventions.

12. The method of claim 1, further comprising determining the first value using a closed-form solution based on the cost, the distribution of expected effect sizes, and the level of expertise.

13. The method of claim 1, wherein the plurality of trials of the experiment are simulated using a simulation model of an experimentation platform.

14. The method of claim 1, further comprising determining a stopping rule comprising a subset of the plurality of interventions to be tested before stopping the experiment.

15. The method of claim 14, wherein each intervention of the subset of the plurality of interventions has an expected value for the intervention that is greater than the cost of the intervention.

16. A system comprising:
a processing device, and
a non-transitory, processor-readable storage medium comprising one or more programming instructions stored thereon that, when executed, cause the processing device to:
receive a cost of performing a controlled experiment to test a plurality of interventions associated with a metric of interest;
receive a distribution of expected effect sizes associated with the plurality of interventions;
receive a level of expertise associated with the metric of interest;
generate sample data for a plurality of simulated trials of the experiment based on the distribution of expected effect sizes;
generate a sample ordering of the plurality of interventions for each of the plurality of simulated trials of the experiment based on the level of expertise associated with the metric of interest;
simulate a plurality of trials of the experiment using the generated sample data and the generated sample orderings of the plurality of interventions; and
determine a first value indicating an amount that the metric of interest will be improved from hiring an expert compared to not hiring an expert based on the results of simulating the plurality of trials.

17. The system of claim 16, wherein:
the cost comprises the cost of testing each of the plurality of interventions;
the distribution of expected effect sizes comprises a gain in the metric of interest expected to be produced by each of the plurality of interventions; and
the level of expertise is based on a similarity between a first ordering of the plurality of interventions, ordered by the gain expected to be produced in the metric of interest for each of the plurality of interventions as predicted by an expert, and a second ordering of the plurality of interventions, ordered by the gain actually produced in the metric of interest for each of the plurality of interventions.

18. The system of claim 16, wherein the plurality of trials of the experiment are simulated on a simulation model of an experimentation platform.

19. The system of claim 16, wherein the instructions, when executed, further cause the processing device to determine a stopping rule comprising a subset of the plurality of interventions to be tested before stopping the experiment.

20. The system of claim 19, wherein each intervention of the subset of the plurality of interventions has an expected value for the intervention that is greater than the cost of the intervention.
